(19) United States
(12) Patent Application Publication
(10) Pub. No.: US 2024/0131750 A1
(43) Pub. Date: Apr. 25, 2024

(54) Granulating Device Die, Granulating Device Cutter Blade Holder, Granulating Device Cutter Blade Unit, Resin-Cutting Device, Granulating Device, and Resin Pellet Manufacturing Method

(71) Applicant: THE JAPAN STEEL WORKS, LTD., Shinagawa-ku, Tokyo (JP)

(72) Inventors: Mitsuhiro SEO, Shinagawa-ku, Tokyo (JP); Masao KURIHARA, Shinagawa-ku, Tokyo (JP)

(21) Appl. No.: 18/271,463

(22) PCT Filed: Sep. 14, 2021
(86) PCT No.: PCT/JP2021/033828

§ 371 Date: Jul. 8, 2023

(30) Foreign Application Priority Data
Feb. 3, 2021 (JP) 2021-015928

(51) Int. Cl. B29B 9/06; B29C 48/00; B29C 48/30

(52) U.S. Cl. CPC B29B 9/06; B29C 48/0022; B29C 48/30

(57) ABSTRACT

Provided are a granulating device die, a granulating device cutter blade holder, a granulating device cutter blade unit, a resin-cutting device, and a granulating device, in all of which an increase in size is suppressed even when the processing amount is increased. The die (10) includes a bottom surface (10B), an upper surface (10A) having a radius smaller than a radius of the bottom surface (10B), a side surface (10C) that connects an outermost peripheral portion of the bottom surface (10B) and an outermost peripheral portion of the upper surface (10A), and a plurality of die holes (11) that discharge a resin raw material, the die holes being defined in the side surface (10C).

### TECHNICAL FIELD

The present disclosure relates to a granulating device die, a granulating device cutter blade holder, a granulating device cutter blade unit, a resin-cutting device, a granulating device, and a resin pellet manufacturing method.

### BACKGROUND ART

Japanese Patent Laying-Open No. 2019-51617 (PTL 1) discloses a granulating device for manufacturing pellets from a resin raw material such as a synthetic resin. The granulating device, a die surface having a die hole for discharging the resin raw material and a blade surface of a cutter blade pressed against the die surface are provided so as to be orthogonal to a rotation axis of a cutter blade unit.

### CITATION LIST

### Patent Literature

PTL 1: Japanese Patent Laying-Open No. 2019-51617

### SUMMARY OF INVENTION

### Technical Problem

In recent years, a granulating device is required to have an increased processing amount. Along with this, sizes of components of the granulating device such as a die and a cutter blade unit, and the granulating device as a whole are increased.

A major object of the present disclosure is to provide a granulating device die, a granulating device cutter blade holder, a granulating device cutter blade unit, a resin-cutting device, and a granulating device, in all of which an increase in size is suppressed even when the processing amount is increased.

Another object of the present disclosure is to provide a resin pellet manufacturing method for manufacturing a large amount of resin pellets using a granulating device die, a granulating device cutter blade holder, a granulating device cutter blade unit, a resin-cutting device, and a granulating device in all of which an increase in size is suppressed.

### Solution to Problem

A granulating device die according to one embodiment of the present disclosure includes: a bottom surface; an upper surface having a radius smaller than a radius of the bottom surface; a side surface that connects an outermost peripheral portion of the bottom surface and an outermost peripheral portion of the upper surface; and a plurality of die holes that discharge a resin raw material, the die holes being defined in the side surface.

A granulating device cutter blade holder according to one embodiment of the present disclosure includes: a cutter shaft that is rotatable and connected to a shaft of a driving motor; and a cutter blade connecting portion that is rotatable and connected to the cutter shaft, the cutter blade connecting portion being for connecting to a plurality of cutter blades. An outer shape of the cutter blade connecting portion is a circular truncated cone shape. A rotation axis of the cutter blade connecting portion is orthogonal to a bottom surface and an upper surface that constitute the circular truncated cone shape. The plurality of cutter blades are connectable to a side surface that constitutes the circular truncated cone shape.

A granulating device cutter blade unit according to one embodiment of the present disclosure includes: a cutter shaft that is rotatable and connected to a shaft of a driving motor; a cutter blade connecting portion that is rotatable and connected to the cutter shaft; and a plurality of cutter blades that are connected to the cutter blade connecting portion. An outer shape of the cutter blade connecting portion is a circular truncated cone shape. A rotation axis of the cutter blade connecting portion is orthogonal to a bottom surface and an upper surface that constitute the circular truncated cone shape. The plurality of cutter blades are connected to a side surface that constitutes the circular truncated cone shape.

A resin-cutting device according to one embodiment of the present disclosure includes: a die that discharges a resin raw material; and a cutter blade unit that pelletizes the discharged resin raw material. The die includes: a bottom surface; an upper surface having a radius smaller than a radius of the bottom surface; a side surface that connects an outermost peripheral portion of the bottom surface and an outermost peripheral portion of the upper surface; and die holes that discharge the resin raw material, the die holes being defined in the side surface.

A granulating device according to one embodiment of the present disclosure includes: a die that discharges a resin raw material; and a cutter blade unit that pelletizes the discharged resin raw material. The die includes: a bottom surface; an upper surface having a radius smaller than a radius of the bottom surface; a side surface that connects an outermost peripheral portion of the bottom surface and an outermost peripheral portion of the upper surface; and die holes that discharge the resin raw material, the die holes being defined in the side surface.

A resin pellet manufacturing method according to one embodiment of the present disclosure includes: (a) discharging a resin raw material from a die of granulating machine; and (b) pelletizing the discharged resin raw material after the (a). The die includes: a bottom surface; an upper surface having a radius smaller than a radius of the bottom surface; a side surface that connects an outermost peripheral portion of the bottom surface and an outermost peripheral portion of the upper surface; and die holes that discharge the resin raw material, the die holes being defined in the side surface.

### Advantageous Effects of Invention

According to the granulating device die, the granulating device cutter blade holder, the granulating device cutter blade unit, the resin-cutting device, and the granulating device of the embodiments of the present disclosure, it is possible to suppress an increase in size even when the processing amount is increased.

According to the resin pellet manufacturing method of the embodiment of the present disclosure, a large amount of resin pellets can be manufactured using the granulating device according to the embodiment of the present disclosure.

### BRIEF DESCRIPTION OF DRAWINGS

FIG. 1 is a view illustrating a granulating device according to one embodiment.

FIG. 2 is a partially enlarged side view illustrating a die, a cutter blade holder, a cutter blade unit, and a resin-cutting device according to one embodiment.

FIG. 3 is a partially enlarged plan view illustrating a die, a cutter blade holder, a cutter blade unit, and a resin-cutting device according to one embodiment.

FIG. 4 is a partially enlarged view of the cutter blade holder, the cutter blade unit, and the resin-cutting device according to one embodiment as viewed from a die side.

FIG. 5 is a partially enlarged cross-sectional view illustrating a die, a cutter blade holder, a cutter blade unit, and a resin-cutting device according to one embodiment.

FIG. 6 is a diagram for describing a method of connecting the die and the cutter blade unit according to one embodiment.

FIG. 7 is a partially enlarged view illustrating a die, a cutter blade holder, and a cutter blade unit according to another embodiment.

FIG. 8 is a partially enlarged view illustrating a die, a cutter blade holder, and a cutter blade unit according to another embodiment.

FIG. 9 is a partially enlarged view illustrating a die, a cutter blade holder, and a cutter blade unit according to another embodiment.

FIG. 10 is a partially enlarged side view illustrating a die, a cutter blade holder, a cutter blade unit, and a resin-cutting device according to a comparative example.

### DESCRIPTION OF EMBODIMENTS

Embodiments of the present disclosure will be described in detail with reference to the drawings. In the following drawings, the same or corresponding parts are denoted by the same reference numerals, and description thereof will not be repeated.

<Configuration of Granulating Device 100>

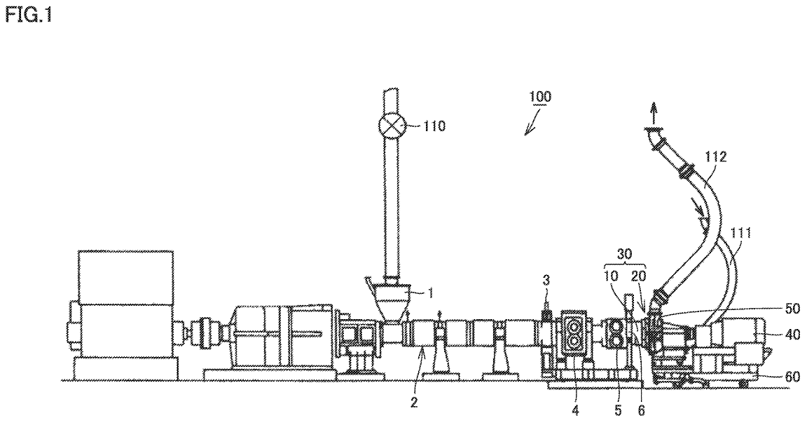

First, a configuration of a granulating device according to one embodiment will be described with reference to FIG. 1. A granulating device 100 shown in FIG. 1 is an underwater cutting type granulating device. Granulating device 100 is connected to a feeder 110, an inflow pipe 111, and an outflow pipe 112. Granulating device 100 processes the resin raw material (hereinafter, simply referred to as a raw material) supplied from feeder 110 into resin pellets (hereinafter, simply referred to as pellets) in a coolant such as water supplied from inflow pipe 111, and discharges the pellets together with the coolant to outflow pipe 112.

As illustrated in FIG. 1, granulating device 100 mainly includes a hopper 1, a screw mixer 2, a diverter valve 3, a gear pump 4, a screen changer 5, a die holder 6, a resin-cutting device 30 configured by connecting a die 10 and a cutter blade unit 20, a motor 40, and a chamber 50.

Feeder 110, hopper 1, screw mixer 2, diverter valve 3, gear pump 4, screen changer 5, die holder 6, and die 10 are connected in this order.

To hopper 1, a fixed amount of raw material per unit time is supplied from feeder 110. Hopper 1 supplies the raw material supplied from feeder 110 to screw mixer 2.

Screw mixer 2 melts and kneads the raw material supplied from hopper 1. Screw mixer 2 supplies the melted and kneaded raw material to diverter valve 3.

Diverter valve 3 switches a flow of the raw material melted and kneaded by screw mixer 2 between a flow into gear pump 4 and a discharge outside granulating device 100.

Diverter valve 3 has an inlet into which the raw material flows from screw mixer 2, an outlet connected to gear pump 4, another outlet connected to outside of granulating device 100, and a valve body. The valve body opens one of two flow paths that connect the inlet disposed in diverter valve 3 and the outlets and closes the other.

Gear pump 4 pushes out the raw material supplied from diverter valve 3 to screen changer 5, die holder 6, and die 10 while pressurizing the raw material.

Screen changer 5 includes a plurality of screens (not illustrated) for removing impurities from the raw material supplied from gear pump 4. The raw material that has passed through screen changer 5 is directed toward die 10 through die holder 6. Here, screen changer 5 includes one or more screens disposed on the flow path of the raw material from gear pump 4 to die 10, one or more screens that are not disposed on the flow path, and an exchange mechanism that exchanges the screens disposed on the flow path. When the one or more screens disposed on the flow path are clogged, screen changer 5 exchanges the screens without stopping granulating device 100.

Die holder 6 detachably holds die 10. Die 10 is screwed to die holder 6, for example. Die holder 6 is provided with a flow path for causing the raw material pushed out from screen changer 5 to flow.

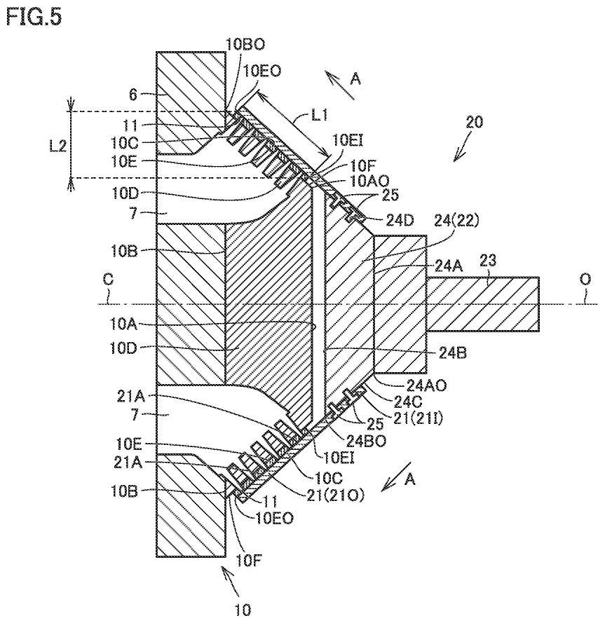

Die 10 is held by die holder 6. Die 10 is provided with a flow path 7 (see FIG. 5) for causing the raw material extruded from the flow path of die holder 6 to flow, and a plurality of die holes 11 (see FIG. 5) for discharging the raw material flowing through the flow path. The raw material pushed out from gear pump 4 and reaching die 10 is discharged outside die 10 through flow path 7 and die holes 11 and processed into elongated cylindrical bodies (hereinafter, referred to as strands).

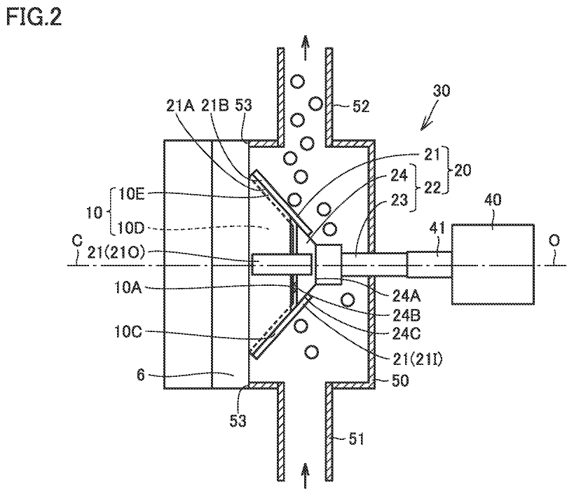

Cutter blade unit 20 cuts the strands discharged from die holes 11 of die 10 and processes the strands into pellets. As illustrated in FIG. 2, cutter blade unit 20 includes cutter blades 21 and a cutter blade holder 22, and rotates about a rotation axis O.

Die 10 and cutter blade unit 20 are accommodated in chamber 50. Chamber 50 is connected to inflow pipe 111 and outflow pipe 112. Chamber 50, inflow pipe 111, and outflow pipe 112 constitute a part of a circulation circuit through which a coolant circulates. During operation of granulating device 100, chamber 50 is filled with a coolant, and the processed pellets are cooled by the coolant. The pellet passes through outflow pipe 112 together with the coolant, is transported to a dewatering/drying machine (not shown), and is dried by the dewatering/drying machine.

Cutter blade unit 20 and chamber 50 are mounted on a carriage 60 and are provided so as to move in a direction along rotation axis O with respect to die 10.

<Configurations of Die 10 and Cutter Blade Unit 20>

Next, detailed configurations of die 10, cutter blade unit 20, and resin-cutting device 30 will be described with reference to FIGS. 2 to 5.

<Configuration of Die 10>

As illustrated in FIG. 2, die 10 includes an upper surface 10A, a bottom surface 10B, and a side surface 10C. Bottom surface 10B is connected to die holder 6. On bottom surface 10B, an inlet for causing the raw material to flow into flow path 7 is provided. Upper surface 10A faces a side opposite to bottom surface 10B, and is disposed with a space from bottom surface 10B in a direction perpendicular to bottom surface 10B. Side surface 10C connects an outermost peripheral portion 10AO of upper surface 10A and an outermost peripheral portion 10BO of bottom surface 10B. The plurality of die holes 11 are defined in side surface 10C.

As illustrated in FIG. 2, a center axis C of die 10 passing through centers of upper surface 10A and bottom surface 10B is orthogonal to both of upper surface 10A and bottom surface 10B. Upper surface 10A is concentric with bottom surface 10B. In side view, side surface 10C is inclined with respect to center axis C. Here, viewing die 10 in side view means that die 10 is viewed from a radial direction with respect to center axis C of die 10.

As illustrated in FIG. 2, in side view, side surface 10C is inclined so as to be away from center axis C from a side of upper surface 10A toward a side of bottom surface 10B. In side view, an angle formed by upper surface 10A and side surface 10C is an obtuse angle, and an angle formed by bottom surface 10B and side surface 10C is an acute angle. In side view, side surface 10C extends linearly, for example.

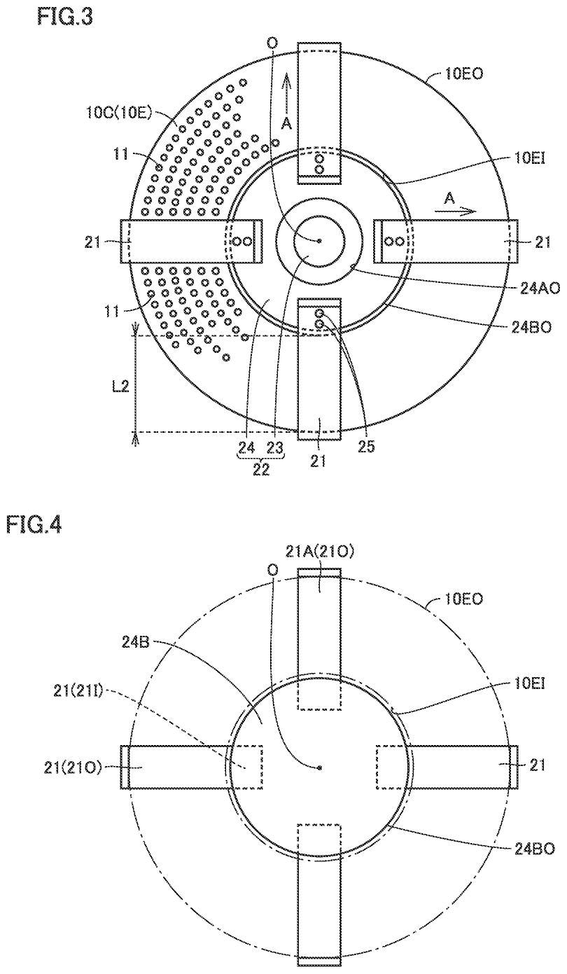

As illustrated in FIG. 3, outer shapes of upper surface 10A and bottom surface 10B are circular in plan view. An outer shape of side surface 10C is an annular shape in plan view. In plan view, an inner peripheral end portion 10EI and an outer peripheral end portion 10EO (details will be described later) of side surface 10C are circular. Upper surface 10A, bottom surface 10B, and side surface 10C of die 10 constitute a circular truncated cone shape. Here, viewing die 10 in plan view means that die 10 is viewed from a direction perpendicular to upper surface 10A. A radius of upper surface 10A is smaller than a radius of bottom surface 10B. In plan view, outermost peripheral portion 10AO of upper surface 10A is disposed inwardly from outermost peripheral portion 10BO of bottom surface 10B.

As illustrated in FIG. 5, the plurality of die holes 11 are defined in side surface 10C. As illustrated in FIG. 5, a hole axis of each die hole 11 is orthogonal to side surface 10C. An inner peripheral surface of each die hole 11 is inclined with respect to the hole axis of each die hole 11, for example. The inner peripheral surface of each die hole 11 is inclined such that a diameter of each die hole 11 decreases toward side surface 10C.

Hardness of the material constituting side surface 10C of die 10 is higher than hardness of the material constituting upper surface 10A of die 10. As illustrated in FIG. 5, die 10 includes, for example, a main body 10D constituting upper surface 10A and bottom surface 10B, and a cured layer 10E constituting side surface 10C. The material constituting cured layer 10E includes, for example, cemented carbide, and includes TiC (titanium carbide), for example.

As illustrated in FIG. 5, main body 10D has a side surface 10F that connects outermost peripheral portion 10AO of upper surface 10A and outermost peripheral portion 10BO of bottom surface 10B. Flow path 7 is provided within main body 10D. Cured layer 10E is provided on side surface 10F of main body 10D. In side surface 10F, an annular portion located on the side of upper surface 10A and an annular portion located on the side of bottom surface 10B are exposed from cured layer 10E. The plurality of die holes 11 are defined so as to penetrate cured layer 10E and reach flow path 7 provided within main body 10D from side surface 10F of main body 10D.

As illustrated in FIG. 5, in the cross section along center axis C, side surface 10F is parallel to side surface 10C, for example. Thickness of cured layer 10E is constant, for example.

As illustrated in FIG. 5, side surface 10C constituted by cured layer 10E has inner peripheral end portion 10EI located on the side of upper surface 10A in the direction along center axis C and on an inner side in the radial direction with respect to center axis C, and outer peripheral end portion 10EO located on the side of bottom surface 10B in the direction along center axis C and on an outer side in the radial direction with respect to inner peripheral end portion 10EI. A radius of inner peripheral end portion 10EI is smaller than a radius of outer peripheral end portion 10EO. In plan view, inner peripheral end portion 10EI is disposed inwardly from outer peripheral end portion 10EO.

Inner peripheral end portion 10EI is connected to outermost peripheral portion 10AO of upper surface 10A via the annular portion exposed from cured layer 10E and positioned on the side of upper surface 10A in side surface 10F of main body 10D and the end surface positioned on the side of upper surface 10A of cured layer 10E. Outer peripheral end portion 10EO is connected to outermost peripheral portion 10BO of bottom surface 10B via the annular portion exposed from cured layer 10E and positioned on the side of bottom surface 10B in side surface 10F of main body 10D and the end surface positioned on the side of bottom surface 10B of cured layer 10E.

Side surface 10C is inclined so as to be away from center axis C from inner peripheral end portion 10EI toward outer peripheral end portion 10EO.

A distance L2 between inner peripheral end portion 10EI and outer peripheral end portion 10EO in the radial direction with respect to center axis C illustrated in FIG. is shorter than a creepage distance L1 between inner peripheral end portion 10EI and outer peripheral end portion 10EO along side surface 10C illustrated in FIG. 5. A projected area of side surface 10C when side surface 10C is projected on a plane orthogonal to center axis C is smaller than an area of side surface 10C.

<Configuration of Cutter Blade Unit 20>

As illustrated in FIGS. 2 to 4, cutter blade unit 20 includes the plurality of (for example, four) cutter blades 21 and cutter blade holder 22 to which cutter blades 21 are fixed. Rotation axis O of cutter blade unit 20 is disposed coaxially with center axis C of die 10.

As illustrated in FIG. 2, cutter blade holder 22 includes a cutter shaft 23 connected to a shaft 41 of driving motor 40, and a cutter blade connecting portion 24 connected to cutter shaft 23 and for connecting the plurality of cutter blades 21. Cutter shaft 23 and cutter blade connecting portion 24 are rotatable about rotation axis O.

Cutter blade connecting portion 24 has, for example, a truncated conical outer shape. Cutter blade connecting portion 24 includes an upper surface 24A, a bottom surface 24B, and a side surface 24C constituting the circular truncated cone shape. Outer shapes of upper surface 24A and bottom surface 24B are circular. A radius of upper surface 24A is smaller than a radius of bottom surface 24B. Rotation axis O passes through centers of upper surface 24A and bottom surface 24B, and is orthogonal to both of upper surface 24A and bottom surface 24B.

Upper surface 24A faces a side opposite to bottom surface 24B, and is disposed with a space from bottom surface 24B in a direction perpendicular to bottom surface 24B. Upper surface 24A is connected to shaft 41 of motor 40 via cutter shaft 23. Bottom surface 24B faces upper surface 10A of die 10. Side surface 24C connects an outermost peripheral portion 24AO of upper surface 24A and an outermost peripheral portion 24BO of bottom surface 24B. The plurality of cutter blades 21 are fixed to side surface 24C. Each cutter blade 21 is fixed to side surface 24C of cutter blade holder 22 by screws 25, for example. Screw holes 24D into which screws 25 are screwed are defined in side surface 24C. Screw holes 22D constitute a fixing portion for fixing cutter blades 21 to side surface 24C.

As illustrated in FIG. 2, in side view, side surface 24C is inclined with respect to rotation axis O. Here, viewing cutter blade unit 20 in side view means that cutter blade unit 20 is viewed from the radial direction with respect to rotation axis O.

As illustrated in FIG. 2, in side view, side surface 24C is inclined so as to be away from rotation axis O from a side of upper surface 24A toward a side of bottom surface 24B. From a different point of view, side surface 24C is inclined so as to be away from rotation axis O from outermost peripheral portion 24AO toward outermost peripheral portion 24BO.

In side view, an angle formed by upper surface 24A and side surface 24C is an obtuse angle, and an angle formed by bottom surface 24B and side surface 24C is an acute angle. In side view, side surface 24C extends linearly, for example.

As illustrated in FIGS. 2 and 3, side surface 24C of cutter blade holder 22 is similar to side surface 10C of die 10. Side surface 24C and side surface 10C are provided so as to respectively constitute different portions of one conical surface centering center axis C and rotation axis O, for example. In side view, the extending direction of side surface 24C is along the extending direction of side surface 10C.

As illustrated in FIGS. 3 and 4, cutter blades 21 are arranged in a rotationally symmetrical manner with respect to rotation axis O. Four cutter blades 21 shown in FIGS. 3 and 4 are arranged in the rotationally symmetrical manner at 90 degrees with respect to rotation axis O.

As illustrated in FIGS. 3 and 4, each cutter blade 21 has an inner portion 211 fixed to cutter blade connecting portion 24 of cutter blade holder 22 and an outer portion 210 protruding from cutter blade connecting portion 24. Outer portion 210 protrudes outward (toward die 10) from outermost peripheral portion 24BO of bottom surface 24B in the direction along rotation axis O. Outer portion 210 protrudes outward from outermost peripheral portion 24BO of bottom surface 24B in the radial direction with respect to rotation axis O.

As illustrated in FIGS. 3 and 4, in plan view, outer portion 210 of each cutter blade 21 extends radially with respect to rotation axis O. In plan view, ab outer shape of outer portion 210 of each cutter blade 21 has a longitudinal direction A along the radial direction with respect to rotation axis O and a lateral direction along a circumferential direction with respect to rotation axis O. Here, viewing cutter blade unit 20 in plan view means that cutter blade unit 20 is viewed from a direction perpendicular to upper surface 24A.

As illustrated in FIG. 5, in a cross section along rotation axis O, outer portion 210 of each cutter blade 21 extends along side surface 10C. In the cross section along rotation axis O, outer portion 210 linearly extends from side surface 24C of cutter blade connecting portion 24.

As illustrated in FIG. 5, outer portion 210 of each cutter blade 21 is provided so as to be in contact with side surface 10C of die 10. Outer portion 210 has, for example, a contact surface 21A provided in surface contact with side surface 10C, and a rake surface 21B forming a rake angle with respect to contact surface 21A. Contact surface 21A of each cutter blade 21 extends along longitudinal direction A of each cutter blade 21. A length of contact surface 21A in longitudinal direction A is equal to or longer than creepage distance L1 of side surface 10C of die 10, and is equal to creepage distance L1, for example. When each contact surface 21A is projected onto a plane orthogonal to rotation axis O, a projected area of contact surface 21A is smaller than the area of contact surface 21A.

Note that cutter blade unit 20 may include one or more cutter blades 21. When cutter blade unit 20 includes an arbitrary number N of cutter blades 21, where N is equal to or greater than 2, N cutter blades 21 are arranged in the rotationally symmetrical manner at (360/N) degrees with respect to rotation axis O.

<Configuration of Resin-Cutting Device 30>

In granulating device 100, a state illustrated in FIGS. 2 and 5 is realized by center axis C of die 10 and rotation axis O of cutter blade unit 20 being coaxially arranged, and cutter blades 21 being pressed against side surface 10C of die 10. The state shown in FIGS. 2 and 5 is a state in which granulating device 100 can be operated. In the present specification, the state illustrated in FIGS. 2 and 5 is referred to as a state in which die 10 and cutter blade unit 20 are connected, and die 10 and cutter blade unit in this connected state are referred to as resin-cutting device 30. In other words, granulating device 100 includes resin-cutting device 30.

In side view, outer portion 210 of each cutter blade 21 extends along side surface 10C of die 10. Here, viewing resin-cutting device 30 in side view means that resin-cutting device 30 is viewed from the radial direction with respect to center axis C and rotation axis O.

In resin-cutting device 30, contact surface 21A of each cutter blade 21 is pressed against and in contact with side surface 10C of die 10. Resin-cutting device is provided such that a contact surface pressure applied between side surface 10C of die 10 and contact surface 21A of cutter blade 21 is uniform in longitudinal direction A.

<Configuration of Chamber 50>

As illustrated in FIG. 2, chamber 50 is provided so as to accommodate die 10 and cutter blade unit 20. Chamber 50 includes an inflow portion 51 into which the coolant flows and an outflow portion 52 from which the coolant and the pellets flow out. Inflow portion 51 is connected to inflow pipe 111. Outflow portion 52 is connected to outflow pipe 112. Inflow portion 51 is disposed below outflow portion 52. Inflow portion 51 is disposed below die 10 and cutter blade unit 20. Outflow portion 52 is disposed above die 10 and cutter blade unit 20. Thus, a flow path of the coolant from the lower side to the upper side is defined in chamber 50. A part of side surface 10C of die 10 located on the side of upper surface 10A is disposed between inflow portion 51 and outflow portion 52 in the vertical direction, for example.

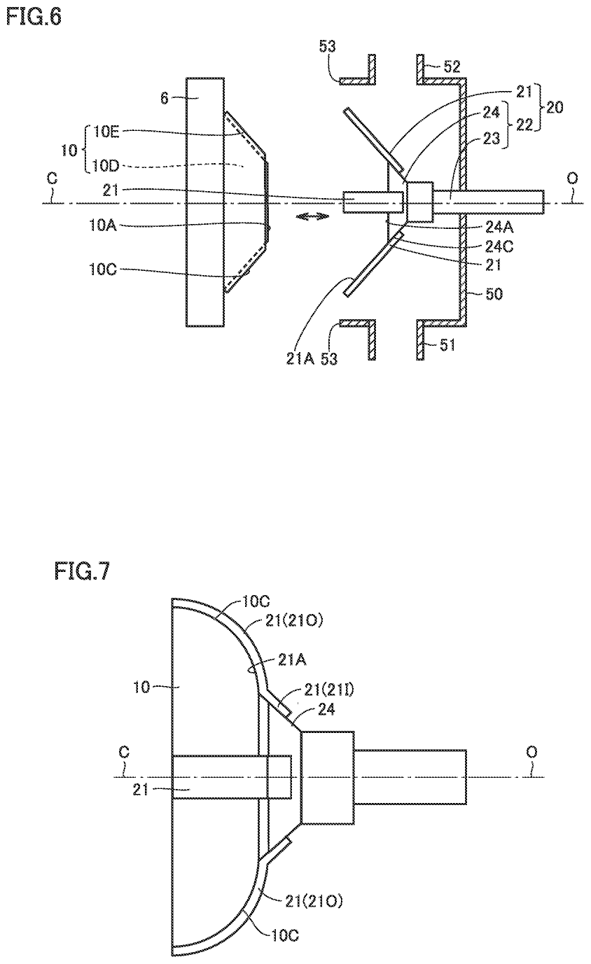

As illustrated in FIG. 6, chamber 50 is mounted on carriage 60 together with cutter blade unit 20, for example, and is provided so as to move integrally with cutter blade unit 20 relative to die 10. An opening 53 is disposed in chamber 50. An opening area of opening 53 is larger than a projected area of die 10 on the plane orthogonal to center axis C and a projected area of cutter blade unit 20 on the plane orthogonal to rotation axis O. As a result, chamber 50 does not interfere with die 10 during the movement. Opening 53 is pressed against die holder 6. Chamber 50 is connected to die holder 6 in a watertight manner.

Chamber 50 is provided with a through hole through which cutter shaft 23 of cutter blade unit 20 or shaft 41 of motor 40 is inserted.

<Pellet Manufacturing Method>

Next, a pellet manufacturing method using granulating device 100 will be described with reference to FIG. 5.

First, the raw material is discharged from die holes 11 of granulating device 100. Next, the raw material discharged from the die holes is pelletized. Specifically, the raw material supplied from feeder 110 reaches flow path 7 of die 10 via hopper 1, screw mixer 2, diverter valve 3, gear pump 4, screen changer 5, and die holder 6. When the raw material reaches flow path 7 of die 10, the raw material has already been melted and kneaded. The melted and kneaded raw material flows from flow path 7 to die holes 11, and is discharged through die holes 11 onto side surface 10C in strands. Immediately after being discharged from die holes 11, the strands are cut by cutter blades 21 whose contact surface 21A is pressed against side surface 10C and rotates about rotation axis O, and processed into pellets. The pellets are cooled by the coolant flowing within chamber 50, flows along the flow of the coolant, and flows out to outflow pipe 112 through outflow portion 52.

Thereafter, the pellets are transported to a dewatering/drying machine (not illustrated) and dried by the dewatering/drying machine. In this way, the pellets are manufactured from the raw material using granulating device 100.

### Modified Example

Hereinafter, a modified example of die 10, cutter blade unit 20, and resin-cutting device 30 according to the present embodiment will be described.

As illustrated in FIGS. 7 to 9, in side view, each of side surface 10C of die 10 and contact surface 21A of cutter blade 21 may be curved. Contact surface 21A of cutter blade 21 is provided so as to be in contact with side surface 10C of die 10.

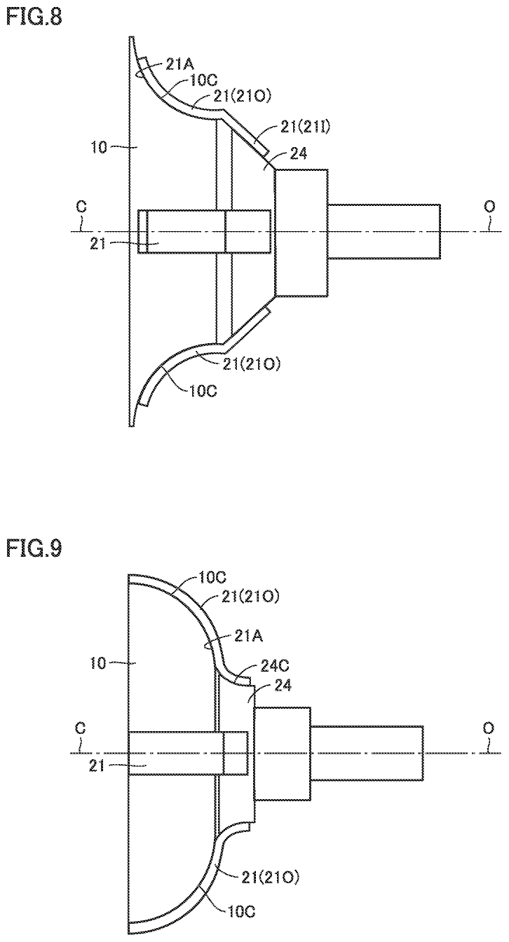

As illustrated in FIG. 7, in side view, the center of curvature of side surface 10C of die 10 may be disposed on an inner side of die 10 with respect to side surface 10C. As illustrated in FIG. 8, in side view, the center of curvature of side surface 10C of die may be disposed on an outer side of die 10 with respect to side surface 10C. In resin-cutting device 30 illustrated in FIGS. 7 and 8, the center of curvature of contact surface 21A of cutter blade 21 is provided so as to overlap the center of curvature of side surface 10C.

As illustrated in FIG. 9, in side view, side surface 24C of cutter blade holder 22 may be curved. The center of curvature of side surface 24C of cutter blade holder 22 may be disposed on an inner side of cutter blade holder 22 with respect to side surface 24C. In side view, the center of curvature of side surface 24C of cutter blade holder 22 may be disposed on an outer side of cutter blade holder 22 with respect to side surface 24C.

Since die 10, cutter blade unit 20, and resin-cutting device 30 as described above also have configurations basically similar to those of die 10, cutter blade unit 20, and resin-cutting device 30 illustrated in FIGS. 2 to 6, similar effects can be obtained.

<Effects>

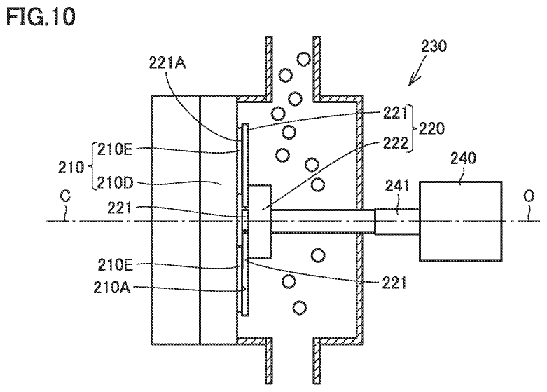

Next, effects of die 10, cutter blade holder 22, cutter blade unit 20, resin-cutting device 30, and granulating device 100 according to the present embodiment will be described based on comparison with a granulating device according to a comparative example (see FIG. 10).

In the granulating device according to the comparative example illustrated in FIG. 10, a processed surface 210A of a die 210 in which die holes are defined and a contact surface 241A of a cutter blade 221 pressed against and in contact with processed surface 210A are provided so as to be orthogonal to center axis C of the die and rotation axis O of the cutter blade unit. Die 210 includes a main body 210D and a cured layer 210E disposed on a surface of main body 210D, and processed surface 210A is a surface of cured layer 210E. In such a comparative example, as processed surface 210A of die 210 in which the die holes are defined and contact surface 241A of cutter blade 221 are increased in size along with an increase in the processing amount, die 210 and cutter blade 221 become large and heavy. Furthermore, in the granulating device of the comparative example, since a cutter blade holder 222 receives a total weight of a plurality of cutter blades 221 and holds them, cutter blade holder 222 also becomes large and heavy. As a result, in the granulating device according to the comparative example, it was difficult to suppress an increase in size of the device along with an increase in the processing amount.

On the other hand, die 10 of granulating device 100 includes bottom surface 10B, upper surface 10A having a radius smaller than that of bottom surface 10B, side surface 10C connecting outermost peripheral portion 10BO of bottom surface 10B and a side of outermost peripheral portion 10AO of upper surface 10A, and the plurality of die holes 11 defined in side surface 10C.

Cutter blade unit 20 of granulating device 100 includes cutter blades 21 and cutter blade holder 22. Cutter blade holder 22 includes bottom surface 24B, upper surface 24A having a maximum width smaller than that of bottom surface 24B, and side surface 24C connecting outermost peripheral portion 24BO of bottom surface 24B and outermost peripheral portion 24AO of upper surface 24A in plan view. Cutter blade 21 has inner portion 211 fixed to side surface 24C and outer portion 210 protruding in the direction along side surface 24C from outermost peripheral portion 24BO of bottom surface 24B.

Resin-cutting device 30 of granulating device 100 includes die 10 and cutter blade unit 20. Rotation axis O of cutter blade unit 20 is disposed coaxially with center axis C of die 10. In side view, outer portion 210 of cutter blade 21 extends along side surface 10C of die 10.

Here, granulating device 100 and the granulating device according to the comparative example that have the same processing amount are compared. The area of side surface 10C of die 10 of granulating device 100 is equal to an area of processed surface 210A in the granulating device according to the comparative example. The area of contact surface 21A of each cutter blade 21 is equal to an area of contact surface 241A of each cutter blade 221 in the granulating device according to the comparative example. On the other hand, the projected area of side surface 10C when side surface 10C is projected on the plane orthogonal to center axis C is smaller than the area of side surface 10C, and therefore is smaller than the area of processed surface 210A in the comparative example. Similarly, when each contact surface 21A is projected onto the plane orthogonal to rotation axis O, the projected area of contact surface 21A is smaller than the area of contact surface 21A, and therefore is smaller than an area of contact surface 211A in the comparative example. In other words, under the above comparison, die 10 is smaller than die 210 of the comparative example, and cutter blade unit 20 is smaller than cutter blade unit 220 of the comparative example.

Therefore, under the above comparison, granulating device 100 can be made smaller than the granulating device according to the comparative example. As a result, maintainability and operability of granulating device 100 are improved as compared with the granulating device according to the comparative example.

In addition, a weight of die 10 can be reduced as compared with die 210 of the comparative example. In other words, a ratio obtained by dividing the weight of die by the area of side surface 10C can be smaller than a ratio obtained by dividing a weight of die 210 of the comparative example by the area of processed surface 210A.

In addition, since die 10 receives a part of a weight of cutter blades 21 moving above side surface 10C of die 10, the weight to be received by cutter blade holder 22 is smaller than a total weight of the plurality of cutter blades. Therefore, a size and/or a weight of cutter blade holder 22 can be reduced as compared with cutter blade holder 222 of the comparative example.

Further, in the granulating device according to the comparative example, since cutter blade holder 222 receives the total weight of the plurality of cutter blades 221, a difference between weights of cutter blade unit 220 on a side of cutter blades 221 and on a side of a shaft 241 becomes relatively large. Therefore, the side of cutter blades 221 may move relatively downward and the side of shaft 241 may move relatively upward, so that cutter blade unit 220 may be inclined with respect to the direction perpendicular to processing surface 210A of die 210. In other words, rotation axis O of cutter blade unit 220 may be inclined with respect to center axis C of die 210. In this case, it is difficult for each cutter blade 221 to be brought into uniform contact with the processed surface of the die.

On the other hand, in granulating device 100, since the weight to be received by cutter blade holder 22 is smaller than the total weight of the plurality of cutter blades, it is difficult for rotation axis O of cutter blade unit 20 to be inclined with respect to center axis C. As a result, each cutter blade 21 can be brought into uniform contact with side surface 10C of die 10.

Further, under the above comparison, a radius of an outermost peripheral portion of each cutter blade 21 is shorter than a radius of an outermost peripheral portion of each cutter blade 221 of the comparative example. Therefore, when the number of rotations is equal under the above comparison, a peripheral speed of each cutter blade 21 is lower than a peripheral speed of each cutter blade 221 of the comparative example. On the other hand, when the peripheral speed is equal under the above comparison, the number of rotations of each cutter blade 21 is greater than the number of rotations of each cutter blade 221 of the comparative example.

In both granulating device 100 and the granulating device of the comparative example, the peripheral speed of the cutter blades is limited from a viewpoint of preventing cavitation in the coolant. According to granulating device 100, the number of rotations of cutter blades 21 can be increased as compared with the comparative example while preventing cavitation to the same extent as the granulating device of the comparative example, and thus, more pellets can be processed with one cutter blade 21. As a result, in granulating device 100, the processing amount of pellets can be increased without increasing the number of cutter blades 21 as compared with the comparative example. From a different point of view, in granulating device 100, the number of cutter blades 21 can be reduced without reducing the pellet manufacturing efficiency as compared with the comparative example.

The configurations of granulating device 100 other than die 10, cutter blade unit 20, and resin-cutting device 30 may be equivalent to the configurations of the granulating device according to the comparative example other than die 210 and cutter blade unit 220. For example, hopper 1, screw mixer 2, diverter valve 3, gear pump 4, and screen changer 5 may have configurations equivalent to those of the granulating device according to the comparative example.

Since the pellet manufacturing method according to the present embodiment uses granulating device 100 whose size is reduced and with improved maintainability and operability as compared with the granulating device according to the comparative example, a large amount of pellets can be manufactured with high efficiency as compared with the pellet manufacturing method using the granulating device according to the comparative example.

Although the embodiments of the present disclosure have been described above, the above-described embodiments can be variously modified. In addition, the scope of the present disclosure is not limited to the above-described embodiments.

### REFERENCE SIGNS LIST

1: hopper, 2: screw mixer, 3: diverter valve, 4: gear pump, 5: screen changer, 6: die holder, 7: flow path, 10: die, 10A: upper surface, 10B: bottom surface, 10C, 10F: side surface, 10D: main body, 10E: cured layer, 10EI: inner peripheral end portion, 10EO: outer peripheral end portion, 11: die hole, 20: cutter blade unit, 21: cutter blade, 21A: contact surface, 21B: rake surface, 211: inner portion, 210: outer portion, 22: cutter blade holder, 23: cutter shaft, 24: cutter blade connecting portion, 24A: upper surface, 24AO: outermost peripheral portion, 24B: bottom surface, 24BO: outermost peripheral portion, 24C: side surface, 24D: screw hole, 25: screw, 30: resin-cutting device, 40: motor, 41: shaft, 50: chamber, 51: inflow portion, 52: outflow portion, 53: opening, 60: carriage, 100: granulating device, 110: feeder, 111: inflow pipe, 112: outflow pipe

1. A granulating device die comprising:
a bottom surface having a circular shape in plan view;
an upper surface having a circular shape in the plan view, the upper surface being concentric with the bottom surface, and having a radius smaller than a radius of the bottom surface;
a side surface that connects an outermost peripheral portion of the bottom surface and an outermost peripheral portion of the upper surface; and
a plurality of die holes that discharge a resin raw material, the die holes being defined in the side surface.

2. The granulating device die according to claim 1, wherein the bottom surface, the upper surface, and the side surface constitute a circular truncated cone shape.

3. The granulating device die according to claim 1, wherein the side surface is curved in side view.

4. The granulating device die according to claim 1, wherein hardness of a material constituting the side surface is higher than hardness of a material constituting the upper surface.

5. A granulating device cutter blade holder comprising:
a cutter shaft that is rotatable and connected to a shaft of a driving motor; and
a cutter blade connecting portion that is rotatable and connected to the cutter shaft, the cutter blade connecting portion being for connecting to a plurality of cutter blades,
wherein an outer shape of the cutter blade connecting portion is a circular truncated cone shape,
a rotation axis of the cutter blade connecting portion is orthogonal to a bottom surface and an upper surface that constitute the circular truncated cone shape, and
the plurality of cutter blades are connectable to a side surface that constitutes the circular truncated cone shape.

6. A granulating device cutter blade unit comprising:
a cutter shaft that is rotatable and connected to a shaft of a driving motor;
a cutter blade connecting portion that is rotatable and connected to the cutter shaft; and
a plurality of cutter blades that are connected to the cutter blade connecting portion,
wherein an outer shape of the cutter blade connecting portion is a circular truncated cone shape,
a rotation axis of the cutter blade connecting portion is orthogonal to a bottom surface and an upper surface that constitute the circular truncated cone shape, and
the plurality of cutter blades are connected to a side surface that constitutes the circular truncated cone shape.

7. A resin-cutting device comprising:
a die that discharges a resin raw material; and
a cutter blade unit that pelletizes the discharged resin raw material,
wherein the die includes:
a bottom surface having a circular shape in plan view;
an upper surface having a circular shape in the plan view, the upper surface being concentric with the bottom surface, and having a radius smaller than a radius of the bottom surface;
a side surface that connects an outermost peripheral portion of the bottom surface and an outermost peripheral portion of the upper surface; and
a plurality of die holes that discharge the resin raw material, the die holes being defined in the side surface.

8. A granulating device comprising:
a die that discharges a resin raw material; and
a cutter blade unit that pelletizes the discharged resin raw material,
wherein the die includes:
a bottom surface having a circular shape in plan view;
an upper surface having a circular shape in the plan view, the upper surface being concentric with the bottom surface, and having a radius smaller than a radius of the bottom surface;
a side surface that connects an outermost peripheral portion of the bottom surface and an outermost peripheral portion of the upper surface; and
a plurality of die holes that discharge the resin raw material, the die holes being defined in the side surface.

9. The granulating device according to claim 8, wherein the bottom surface, the upper surface, and the side surface constitute a circular truncated cone shape.

10. The granulating device according to claim 8, further comprising a chamber that accommodates the die and the cutter blade unit,
wherein the chamber includes:
an inflow portion into which liquid flows; and
an outflow portion through which the liquid and pellets pelletized by the cutter blade unit flow out.

11. The granulating device according to claim 8, wherein
the cutter blade unit includes:
a cutter shaft that is rotatable and connected to a shaft of a driving motor;
a cutter blade connecting portion that is rotatable and connected to the cutter shaft; and
a plurality of cutter blades that are connected to the cutter blade connecting portion,
wherein an outer shape of the cutter blade connecting portion is a circular truncated cone shape,
a rotation axis of the cutter blade connecting portion is orthogonal to a bottom surface and an upper surface that constitute the circular truncated cone shape,
the plurality of cutter blades are connected to a side surface that constitutes the circular truncated cone shape, and
the plurality of cutter blades rotate along the side surface of the die.

12. A resin pellet manufacturing method comprising:
(a) discharging a resin raw material from a die of granulating machine; and
(b) pelletizing the discharged resin raw material after the (a),
wherein the die includes:
a bottom surface having a circular shape in plan view;
an upper surface having a circular shape in the plan view, the upper surface being concentric with the bottom surface, and having a radius smaller than a radius of the bottom surface;
a side surface that connects an outermost peripheral portion of the bottom surface and an outermost peripheral portion of the upper surface; and
a plurality of die holes that discharge the resin raw material, the die holes being defined in the side surface.

13. The resin pellet manufacturing method according to claim 12, wherein the bottom surface, the upper surface, and the side surface constitute a circular truncated cone shape.
